(19) United States
(12) Patent Application Publication
(10) Pub. No.: US 2006/0166621 A1
(43) Pub. Date: Jul. 27, 2006

(54) Method and apparatus for effectively performing WUSB communication

(75) Inventors: Dae-gyu Bae, Suwon-si (KR); Hyun-ah Sung, Seoul (KR); Jin-woo Hong, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/223,975

(22) Filed: Sep. 13, 2005

(30) Foreign Application Priority Data
Jan. 27, 2005 (KR) 10-2005-0007628

(51) Int. Cl. H04B 7/00

(52) U.S. Cl. 455/41.2

(57) ABSTRACT

A method and apparatus for wireless universal serial bus (WUSB) communication are provided. The communication method for a host includes allocating a dedicated channel interval, which is an interval in which an allocated device can use the channel of the wireless interface exclusively, to the allocated device from among devices connected through a wireless interface; transmitting information on the allocation to the allocated device; and communicating exclusively with the allocated device during the exclusive channel interval, such that micro-scheduling is not needed in this interval, which improves the throughput of the WUSB communication.

### CROSS-REFERENCE TO RELATED PATENT APPLICATIONS

This application claims priority from Korean Patent Application No. 10-2005-0007628, filed on Jan. 27, 2005, in the Korean Intellectual Property Office, the disclosure of which is incorporated herein in its entirety by reference.

### BACKGROUND OF THE INVENTION

1. Field of the Invention

The present invention relates to wireless universal serial bus (WUSB) communication, and more particularly, to a method and apparatus for efficiently performing WUSB communication.

2. Description of the Related Art

Universal serial bus (USB) is a representative interface standard for interfacing a personal computer (PC) and its peripherals, and expanding its application scope to include consumer electronics (CE) and mobile devices. In line with developing wireless communication environments, conventional wired communication standards, such as USB, are being requested to support wireless communication. This has prompted the creation of the WUSB standard to support wireless communication of USB devices.

The WUSB standard was originally based on the media access control (MAC) of the Institute of Electrical and Electronics Engineers (IEEE) 802.15.3 standard, but is currently being modified based on the MAC of the MultiBand OFDM (orthogonal frequency division multiplexing) Alliance (MBOA).

The IEEE 802.15.3 standard defines a piconet that is a wireless personal area network (WPAN) formed with a plurality of devices. One of the devices in the piconet becomes a piconet coordinator (PNC). The PNC manages the timing, quality of services (QoS), power, etc. of the piconet. The WUSB standard, based on the IEEE 802.15.3 standard, requires a WUSB host to be a PNC with a micro-scheduling function. An example of the WUSB host is a PC. Examples of WUSB devices include PC peripherals such as a keyboard, a mouse, and a digital camera. WUSB devices use a WUSB information element (IE) in order to identify a WUSB host.

FIG. 1 illustrates a WUSB micro-schedule stream.

Referring to FIG. 1, the WUSB micro-schedule stream, based on the IEEE 802.15.3 standard, is formed with super frames that are the basic time divisions. A super frame is formed with a beacon, a contention access period (CAP), and a contention free period (CFP).

The beacon is used to set timing allocations and transfer WUSB IEs. The CAP is used to transfer commands and asynchronous data. The CFP is formed with micro-scheduled private-channel time allocations (MP-CTAs) and channel time allocations (CTAs). The MP-CTA includes a micro-scheduled management command (MMC) and CTAs described in the MMC.

The MMC includes W_{X}CTA blocks corresponding to a USB token. Types of WXCTA blocks include a W_{DR}CTA (device receive) block, a W_{DT}CTA (device transmit) block, and a W_{DNTS}CTA (device notification time slot) block. The W_{DR}CTA block includes information on an interval in which a device receives data from a host, the W_{DT}CTA block includes information on an interval in which a device transmits data to a host, and the W_{DNTS}CTA block includes information on an interval in which a device transmits information on itself to a host.

FIG. 2 shows the structures of the conventional USB transaction protocol and WUSB transaction protocol.

Referring to FIG. 2, the conventional USB transaction protocol shown at the top is formed with a token transmission interval, a data transmission interval, and a handshake transmission interval. This indicates that the USB transaction protocol completes one transaction with the token, data, and handshake. Meanwhile, the conventional WUSB transaction protocol is formed with an MMC transmission interval and a CTA interval. The MMC transmission interval is formed with a header, W_{DR}CTA (Token 0), W_{DT}CTA (Token 1), and W_{DT}CTA (Hndsk 0), and the CTA interval is formed with a data output interval, a data input interval, and a handshake output interval.

The WUSB transaction protocol performs time scheduling in micro units, that is, micro-scheduling, for allocating CTA intervals to respective devices, and uses the MMC to inform the devices of the result. That is, the WUSB transaction protocol completes one transaction with the MMC, data, and handshake.

However, according to the conventional WUSB transaction protocol, a host or a device cannot transmit data immediately after preparing the data. After the host performs micro-scheduling and transmits the result using the MMC, and the device can transmit data only in the CTA interval allocated to it. This delays data transmission between the host and devices.

In particular, in the case of an application transmitting data periodically, the MMC must be transmitted each time, which is a waste of bandwidth.

Also, in the case of an application requiring bulk transfer or isochronous transfer, the data must be divided and transmitted, and every transmission must include an MMC. Therefore, the original bulk transfer or isochronous transfer cannot be performed.

### SUMMARY OF THE INVENTION

The present invention provides a method and apparatus capable of more efficiently performing WUSB communication by avoiding data transmission delay due to micro-scheduling and MMC transmission.

The present invention also provides a computer readable recording medium having embodied thereon a computer program for performing the method.

According to an aspect of the present invention, there is provided a communication method of a host connected to a plurality of devices through a wireless interface, the method comprising: allocating to an allocated device from among the devices a dedicated channel interval, which is an interval in which the allocated device can use the channel of the wireless interface exclusively; transmitting information on the allocation to the allocated device; and communicating exclusively with the allocated device during the dedicated channel interval.

According to another aspect of the present invention, there is provided a communication apparatus of a host connected to a plurality of devices through a wireless interface, the apparatus comprising: an allocation unit which allocates to an allocated device from among the devices a dedicated channel interval, which is an interval in which the allocated device can use the channel of the wireless interface exclusively; a notification unit which transmits information on the allocation from the allocation unit to the allocated device; and a communication unit which communicates exclusively with the allocated device during the exclusive channel interval.

According to another aspect of the present invention, there is provided a computer readable recording medium having embodied thereon a computer program for performing the communication method of a host connected to a plurality of devices through a wireless interface.

According to another aspect of the present invention, there is provided a communication method of an allocated device among a plurality of devices connected to a host through a wireless interface, the method comprising: requesting allocation of a dedicated channel interval in which allocated the device can exclusively use the channel of the wireless interface; receiving allocation information of the dedicated channel interval as a response to the request; and based on the received allocation information, performing exclusive communication with the host during the dedicated channel interval.

According to another aspect of the present invention, there is provided a communication apparatus of an allocated device among a plurality of devices connected to a host through a wireless interface, the apparatus comprising: a request unit which requests allocation of a dedicated channel interval, in which the allocated device can exclusively use the channel of the wireless interface; a reception unit which receives allocation information of the dedicated channel interval as a response to the request; and a communication unit which communicates exclusively with the host during the dedicated channel interval based on the received allocation information.

According to another aspect of the present invention, there is provided a computer readable recording medium having embodied thereon a computer program for performing the communication method of an allocated device among a plurality of devices connected to a host through a wireless interface.

### BRIEF DESCRIPTION OF THE DRAWINGS

The above and other aspects of the present invention will become more apparent by describing in detail exemplary embodiments thereof with reference to the attached drawings in which:

FIG. 1 illustrates a WUSB micro-schedule stream;

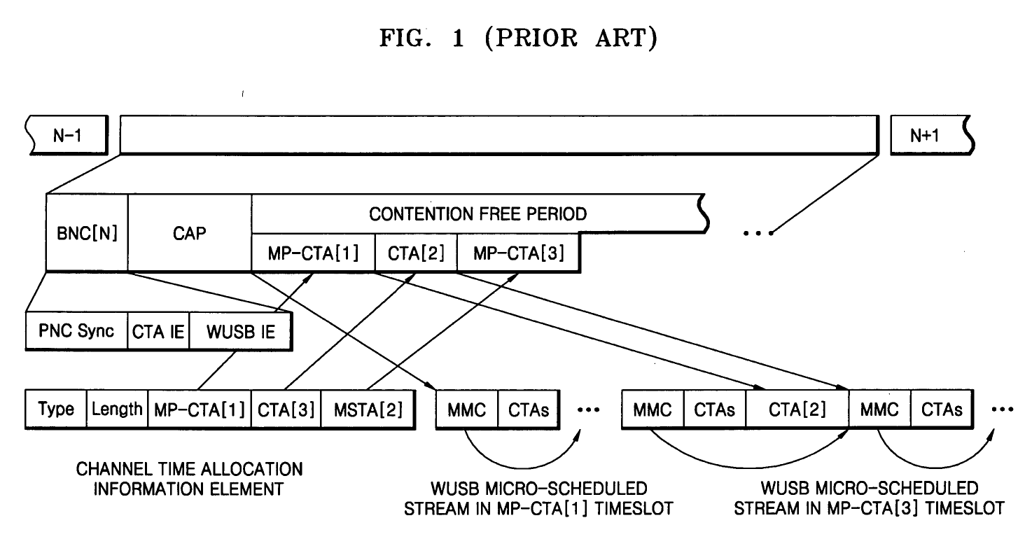

FIG. 2 shows the structures of the conventional USB transaction protocol and WUSB transaction protocol;

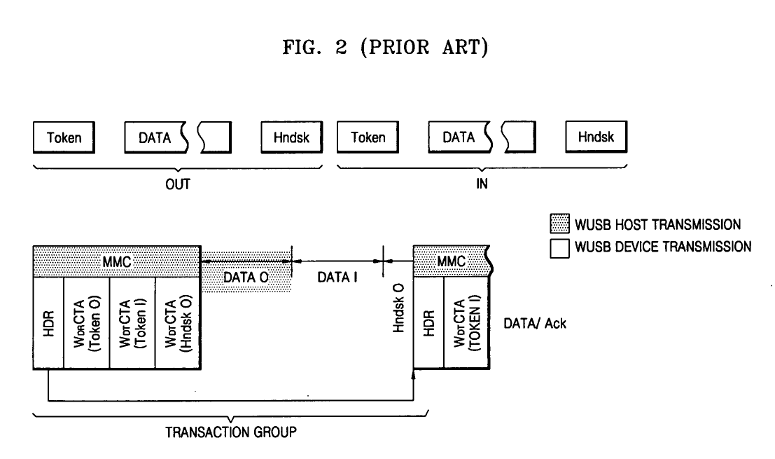

FIG. 3 shows the structure of a WUSB transaction protocol according to an exemplary embodiment of the present invention;

FIG. 4 shows the structure of a WUSB communication system according to an exemplary embodiment of the present invention;

FIG. 5 shows the format of a W_{dedicated}CTA block according to an exemplary embodiment of the present invention;

FIG. 6 is a flowchart of the operations performed by a WUSB host communication method according to an exemplary embodiment of the present invention; and

FIG. 7 is a flowchart of the operations performed by a WUSB device communication method according to an exemplary embodiment of the present invention.

### DETAILED DESCRIPTION OF THE EXEMPLARY EMBODIMENTS OF THE PRESENT INVENTION

Exemplary embodiments of the present invention will now be described more fully with reference to the accompanying drawings.

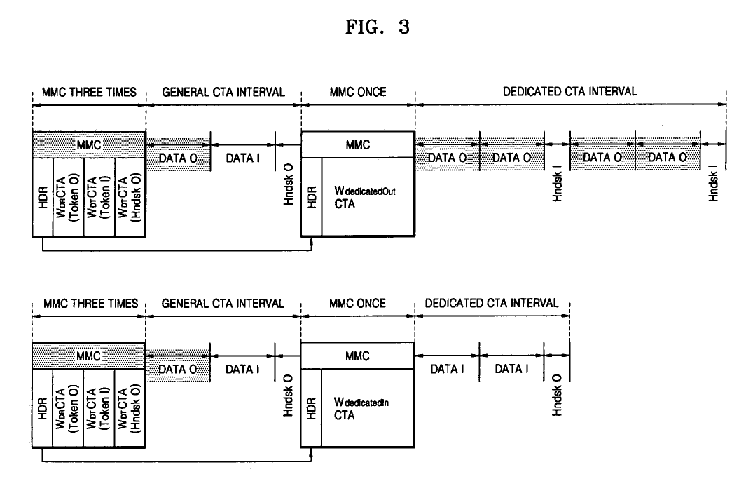

Referring to FIG. 3, the WUSB transaction protocol shown at the top is formed with an MMC three times transmission interval, a general CTA interval, an MMC transmission interval, and a dedicated CTA interval. The MMC three times transmission interval and the general CTA interval comply with the conventional WUSB transaction protocol. A host performs micro-scheduling for devices connected to the host, and according to the result, transmits an MMC for each of W_{DR}CTA (Token 0), W_{DT}CTA (Token 1), and W_{DT}CTA (Hndsk 0), three times. Each of the devices receiving the MMC performs data transmission and reception with the host in an interval allocated to the device in the general CTA interval.

Meanwhile, the MMC once transmission interval and the dedicated CTA interval comply with a WUSB transaction protocol according to an exemplary embodiment of the present invention. In these intervals, the host does not perform micro-scheduling for the devices connected to the host, and allocates a dedicated CTA interval to a device to which the host desires to transmit data exclusively, and according to the result, transmits an MMC for W_{dedicatedOut}CTA once. The device receiving this MMC receives data from the host in the dedicated CTA interval. In particular, the WUSB transaction protocol shown at the top in FIG. 3 is a case where the host performs bulk transfer with a burst size of 2 units to a device, and data is output twice by the host. Then, the host receives a handshake corresponding to ACK and confirms from this whether or not the data is transmitted normally.

Referring to FIG. 3, the WUSB transaction protocol shown at the bottom is formed with an MMC three times transmission interval, a general CTA interval, an MMC once transmission interval, and a dedicated CTA interval. The MMC three times transmission interval and the general CTA interval comply with the conventional WUSB transaction protocol and are the same as the WUSB transaction protocol shown at the top of FIG. 3.

Meanwhile, the MMC once transmission interval and the dedicated CTA interval comply with the WUSB transaction protocol according to an exemplary embodiment of the present invention. In these intervals, the host does not perform micro-scheduling for the devices connected to the host, and allocates a dedicated CTA interval to a device which desires to transmit data to the host exclusively, and according to the result, transmits an MMC for W_{dedicatedIn}CTA once. The device receiving this MMC transmits data to the host in the dedicated CTA interval. In particular, the WUSB transaction protocol shown at the bottom of FIG. 3 is a case where the device performs bulk transfer with a burst size of 2 units to the host, and data is input twice by the host. Then, the host outputs a handshake corresponding to ACK and the device confirms from this whether or not the data is transmitted normally.

As described above, in the interval complying with the WUSB transaction protocol according to an exemplary embodiment of the present invention, the host needs to transmit the MMC only once, and one of the devices connected to the host can perform exclusive communication with the host in the dedicated CTA interval.

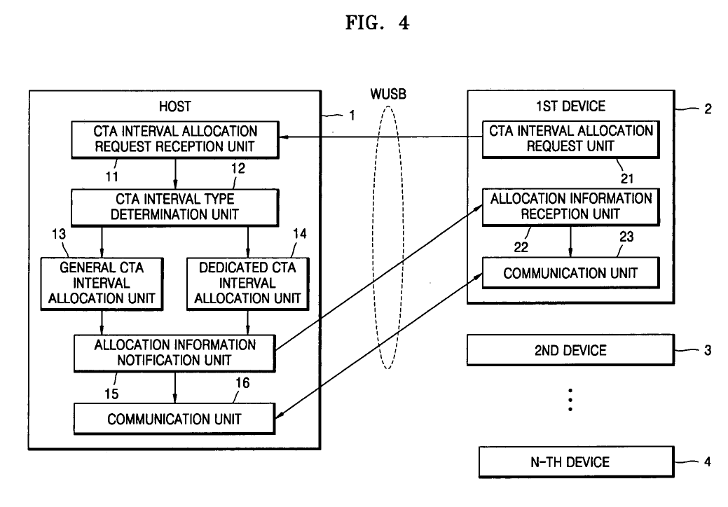

FIG. 4 shows the structure of a WUSB communication system according to an exemplary embodiment of the present invention.

Referring to FIG. 4, the WUSB communication system, according to an exemplary embodiment of the present invention, includes a host 1 and a plurality of devices 2 through 4.

The host 1 and the plurality of devices 2 through 4 are connected through the WUSB. Hereinafter, all specifications other than those proposed in the present exemplary embodiment will comply with the WUSB standard.

The host 1 includes a CTA interval allocation request reception unit 11, a CTA interval type determination unit 12, a general CTA interval allocation unit 13, a dedicated CTA interval allocation unit 14, an allocation information notification unit 15, and a communication unit 16.

During a W_{DNTS}CTA interval, the CTA interval allocation request reception unit 11 receives an allocation request from a first device 2 for a CTA interval in which the first device 2 can use the WUSB channel. The host 1 can receive information on the devices 2 through 4 from the devices 2 through 4 during the W_{DNTS}CTA interval. That is, during this W_{DNTS}CTA interval, the CTA interval allocation request reception unit 11 receives an allocation request for a CTA interval by receiving a message from the first device 2, including the length of the CTA interval and the communication type between the host 1 and the first device 2.

The CTA interval type determination unit 12 determines the type of the CTA interval based on the allocation request received by the CTA interval allocation request reception unit 11. More specifically, if the type of communication included in a message corresponding to the allocation request received by the CTA interval allocation request reception unit 11 indicates a general transmission, the CTA interval type determination unit 12 determines the type of a CTA interval to be used by the first device 2 to be a general CTA interval, in which the WUSB channel can be used by the first device 2 together with other devices 3 and 4.

If the type of communication included in the message corresponding to the allocation request received by the CTA interval allocation request reception unit 11 indicates a bulk transfer or an isochronous transfer, the CTA interval type determination unit 12 determines the type of the CTA interval to be a dedicated CTA interval, in which the first device 2 can use the WUSB channel exclusively.

If the type of the CTA interval is determined to be a general CTA interval by the CTA interval type determination unit 12, the general CTA interval allocation unit 13 allocates a general CTA interval to the first device 2. More specifically, if the type of the CTA interval is determined to be a general CTA interval by the CTA interval type determination unit 12, the general CTA interval allocation unit 13 performs time scheduling in micro units, that is, micro-scheduling, to allocate general CTA intervals to each of the plurality of devices 2 through 4, and according to the result, allocates a part of the CTA interval.

If the type of the CTA interval is determined to be a dedicated CTA interval by the CTA interval type determination unit 12, the dedicated CTA interval allocation unit 14 allocates a dedicated CTA interval to the first device 2. More specifically, if the type of the CTA interval is determined to be a dedicated CTA interval by the CTA interval type determination unit 12, the dedicated CTA interval allocation unit 14 does not perform the micro-scheduling described above, and allocates the entire CTA interval to the first device 2.

The allocation information notification unit 15 transmits the allocation information from the general CTA interval allocation unit 13 or the dedicated CTA interval allocation unit 14, to the first device 1. More specifically, the allocation information notification unit 15 transmits the allocation information in the general CTA interval allocation unit 13 by transmitting an MMC containing the start time and length of a general CTA interval several times to the plurality of devices 2 through 4. Also, the allocation information notification unit 15 transmits the allocation information in the dedicated CTA interval allocation unit 14, by transmitting an MMC containing the start time and length of a dedicated CTA interval to the first device 1.

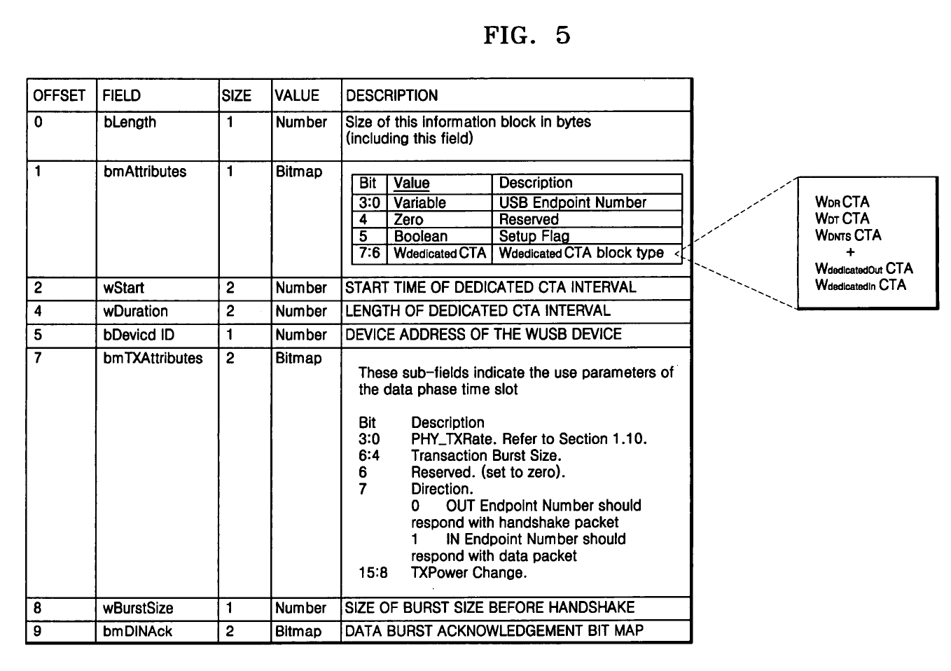

FIG. 5 shows the format of a W_{dedicated}CTA block, according to an exemplary embodiment of the present invention.

Referring to FIG. 5, the format of the W_{dedicated}CTA block, according to the present exemplary embodiment, is the same as that of the conventional W_{X}CTA block complying with the WUSB standard. However, the W_{dedicated}CTA block has additional possible values for the fields of the W_{X}CTA block. In the bmAttributes field, values indicating a W_{dedicatedOut}CTA and a W_{dedicatedIn}CTA are added, in addition to the values indicting W_{DR}CTA, W_{DT}CTA and W_{DNTS}CTA. Also, in the wStart field, a value indicating the start time of a dedicated CTA interval is added, in addition to a value indicating the start time of a general CTA interval. In the wDuration field, a value indicating the length of a dedicated CTA interval is added, in addition to a value indicating the length of a general CTA interval. That is, the allocation information notification unit 15 transmits the allocation information from the dedicated CTA interval allocation unit 14, by transmitting an MMC including the W_{dedicated}CTA block having the format shown in FIG. 5 once to the first device 1.

As described above, when the host 1 allocates a dedicated CTA interval only to the first device 2, micro-scheduling is not performed. According to the WUSB standard, the MMC is used to transmit the result of micro-scheduling, that is, the allocation information, to the plurality of devices 2 through 4. Accordingly, when the host 1 does not perform micro-scheduling, the MMC may not be transmitted. In this case, the allocation information notification unit 15 can transmit allocation information from the dedicated CTA interval allocation unit 14, by transmitting a beacon containing the start time and length of a dedicated CTA interval. The beacon is a packet to broadcast synchronization information and the like between the host 1 and the devices 2 through 4 before the host 1 broadcasts an MMC to the devices 2 through 4.

The communication unit 16 communicates with the plurality of devices receiving the notification from the allocation information notification unit 15 during a general CTA interval, or communicates exclusively with the device (e.g., first device 2) receiving the notification from the allocation information notification unit 15, during the dedicated CTA interval.

More specifically, the communication unit 16 communicates by transmitting data periodically to the plurality of devices 2 through 4 receiving the allocation information in the general CTA interval during the general CTA interval, or by receiving data periodically from these devices 2 through 4. Also, during the dedicated CTA interval, the communication unit 16 communicates by transmitting data periodically to only the first device 2 receiving the allocation information from the dedicated CTA interval allocation unit 14, and by receiving data periodically from only the first device 2.

Referring to FIG. 4, the first device 2 includes a CTA interval allocation request unit 21, an allocation information reception unit 22, and a communication unit 23.

During the W_{DNTS}CTA interval, the CTA interval allocation request unit 21 requests allocation of an interval in which the first device 2 can use the WUSB channel. More specifically, the CTA interval allocation request unit 21 requests allocation of an interval in which the WUSB channel can be used, by transmitting a message containing the length of a CTA interval and the type of communication between the host 1 and the first device 2. According to the present exemplary embodiment, the CTA interval allocation unit 21 requests allocation of a dedicated CTA interval by transmitting a message indicating that the type of communication is a bulk transfer or an isochronous transfer, during the W_{DNTS}CTA interval.

The allocation information reception unit 22 receives allocation information on a dedicated CTA interval as a response to the request from the CTA interval allocation request unit 21. More specifically, the allocation information reception unit 22 receives the allocation information by receiving one MMC including the start time and length of the dedicated CTA interval from the host 1. Also, the allocation information reception unit 22 may receive the allocation information by receiving a beacon including the start time and length of the dedicated CTA interval from the host 1.

The communication unit 23 communicates exclusively with the host 1 during the dedicated CTA interval based on the allocation information received by the allocation information reception unit 22. More specifically, the communication unit 23 transmits data to and receives data from the host 1 periodically during the dedicated CTA interval corresponding to the start time and length of the dedicated CTA interval included in the MMC or beacon received by the allocation information reception unit 22.

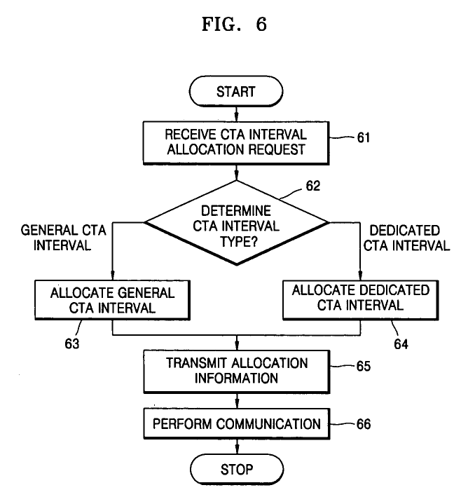

FIG. 6 is a flowchart of the operations performed by a WUSB host communication method, according to an exemplary embodiment of the present invention.

Referring to FIG. 6, the WUSB host communication method, according to the present exemplary embodiment, will now be explained. The operations of the WUSB host communication method, according to the present exemplary embodiment, are processed sequentially by the host shown in FIG. 4. Accordingly, any parts that are described above in relation to the host 1 and omitted hereinafter also apply to the WUSB host communication method according to the present exemplary embodiment.

In operation 61, during the W_{DNTS}CTA interval, the host receives an allocation request from the first device 2 for a CTA interval in which the first device 2 can use the WUSB channel.

In operation 62, the host 1 determines the type of the CTA interval based on the allocation request received in operation 61. More specifically, in operation 62, if the type of communication included in a message corresponding to the allocation request received in operation 61 indicates a general transmission, the host 1 determines the type of the CTA interval to be used by the first device 2 to be a general CTA interval in which the WUSB channel can be used by the first device 2 together with the other devices 3 and 4.

In operation 62, if the type of communication included in the message corresponding to the allocation request received in operation 61 indicates a bulk transfer or an isochronous transfer, the host 1 determines the type of the CTA interval to be a dedicated CTA interval in which the first device 2 can use the WUSB channel exclusively.

In operation 63, if the type of the CTA interval is determined to be a general CTA interval, the host 1 allocates a general CTA interval to the first device 2.

In operation 64, if the type of the CTA interval is determined to be a dedicated CTA interval, the host 1 allocates a dedicated CTA interval to the first device 2.

In operation 65, the host transmits the allocation information obtained in operation 63 to the first device 2 (as well as devices 3 and 4) or the allocation information obtained in operation 64 to the first device 2.

In operation 66, the host 1 communicates with the plurality of devices 2 through 4 receiving the notification in operation 65, during the general CTA interval, or communicates exclusively with the first device 2 receiving the notification in operation 65, during the dedicated CTA interval.

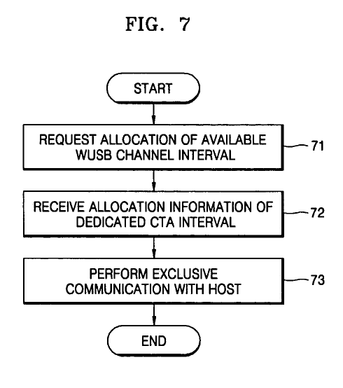

FIG. 7 is a flowchart of the operations performed by a WUSB device communication method according to an exemplary embodiment of the present invention.

Referring to FIG. 7, the WUSB device communication method, according to an exemplary embodiment of the present invention, will now be explained. The operations of the WUSB device communication method according to the present exemplary embodiment are processed sequentially by a device (e.g., the first device 2) shown in FIG. 4. Accordingly, any parts that are described above in relation to the first device 2 and omitted hereinafter also apply to the WUSB device communication method according to the present exemplary embodiment.

In operation 71, during a W_{DNTS}CTA interval, the first device 2 requests allocation of an interval in which the WUSB channel can be used. According to the present exemplary embodiment, the first device 2 requests the allocation of a dedicated CTA interval, by transmitting a message indicating that the type of communication is a bulk transfer or an isochronous transfer, during the W_{DNTS}CTA interval.

In operation 72, the first device 2 receives allocation information on a dedicated CTA interval as a response to the request in operation 71.

In operation 73, the first device 2 communicates exclusively with the host 1 during the dedicated CTA interval based on the allocation information received in operation 72.

Exemplary embodiments of the present invention can be written as computer programs and can be implemented in general-use digital computers that execute the programs using a computer readable recording medium. Also, the data structures used in the exemplary embodiments of the present invention described above can be recorded on a computer readable recording medium in a variety of ways.

Examples of the computer readable recording medium include magnetic storage media (e.g. ROM, floppy disks, hard disks, etc.), optical recording media (e.g. CD-ROMs, DVDs, etc.), and storage media such as carrier waves (e.g., transmissions through the Internet).

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in a descriptive sense only and not for purposes of limitation. Therefore, the scope of the invention is defined not by the detailed description of the exemplary embodiments of the present invention but by the appended claims, and all differences within the scope will be construed as being included in the present invention.

According to the exemplary embodiments of the present invention, by introducing a dedicated CTA interval in which a host can communicate exclusively with only one device, micro-scheduling is not needed in this interval, allowing higher throughput of the WUSB communication.

In particular, when the host transmits allocation information of a dedicated CTA interval to a device, an MMC including the allocation information of the dedicated CTA interval needs to be transmitted only once. Accordingly, the problem of data transmission delay due to MMC transmission can be solved. Also, by including and transmitting allocation information of a dedicated CTA interval in a beacon instead of in an MMC, the throughput of the WUSB communication can be maximized.

Furthermore, in the case of an application which transmits data periodically, bandwidth waste due to the MMC transmission is reduced, and in the case of an application which requires bulk transfer or isochronous transfer, the original bulk transfer or isochronous transfer can be readily performed.

What is claimed is:

1. A communication method of a host connected to a plurality of devices through a wireless interface, the method comprising:
allocating a dedicated channel interval, which is an interval in which an allocated device among the devices can use a channel of the wireless interface exclusively, to the allocated device;
transmitting information on the dedicated channel interval to the allocated device; and
communicating exclusively with the allocated device during the dedicated channel interval.

2. The method of claim 1, further comprising:
receiving an allocation request for an interval in which the allocated device can use the channel, from the allocated device; and
determining a type of the interval in which the channel is to be used, based on the allocation request.

3. The method of claim 2, wherein the receiving the allocation request comprises receiving a message including a length of the dedicated channel interval and a type of a communication between the host and the allocated device, and
wherein the determining the type of the interval comprises determining the type of the interval is a dedicated channel interval, if the type of the communication indicates a bulk transfer or an isochronous transfer.

4. The method of claim 1, wherein the communicating exclusively with the allocated device comprises periodically transmitting data to, or receiving data from, only the allocated device during the dedicated channel interval.

5. The method of claim 1, wherein the wireless interface is a wireless universal serial bus, and the dedicated channel interval is a dedicated channel time allocation.

6. The method of claim 5, wherein the transmitting the information on the dedicated channel interval comprises transmitting a micro-scheduled management command, including a start time and a length of the dedicated channel time allocation interval, once to the allocated device.

7. The method of claim 5, wherein the transmitting the information on the dedicated channel interval comprises transmitting a beacon, including a start time and a length of the dedicated channel time allocation interval, to the allocated device.

8. A communication apparatus of a host connected to a plurality of devices through a wireless interface, the apparatus comprising:
an allocation unit which allocates a dedicated channel interval, which is an interval in which an allocated device among the devices can use a channel of the wireless interface exclusively, to the allocated device;
a notification unit which transmits information on the dedicated channel interval from the allocation unit to the allocated device; and
a communication unit which communicates exclusively with the allocated device during the exclusive channel interval.

9. A computer readable recording medium having embodied thereon a computer program for a communication method of a host connected to a plurality of devices through a wireless interface, wherein the method comprises:
allocating a dedicated channel interval, which is an interval in which an allocated device among the devices can use a channel of the wireless interface exclusively, to the allocated device;
transmitting information on the dedicated channel interval to the allocated device; and
communicating exclusively with the allocated device during the exclusive channel interval.

10. A communication method of a first device of a plurality of devices connected to a host through a wireless interface, the method comprising:
requesting allocation of a dedicated channel interval in which the first device can exclusively use a channel of the wireless interface;
receiving information on the dedicated channel interval in response to the request; and
communicating exclusively with the host during the dedicated channel interval, based on the information on the dedicated channel interval.

11. The method of claim 10, wherein the requesting allocation of the dedicated channel interval comprises transmitting a message including a length of the dedicated channel interval and a type of a communication between the host and the first device.

12. The method of claim 11, wherein the message indicates that the type of the communication is a bulk transfer or an isochronous transfer.

13. The method of claim 10, wherein the wireless interface is a wireless universal serial bus, and the dedicated channel interval is a dedicated channel time allocation.

14. The method of claim 13, wherein the receiving the information on the dedicated channel interval comprises receiving a micro-scheduled management command, including a start time and a length of the dedicated channel time allocation interval, once from the host.

15. The method of claim 13, wherein the receiving the information on the dedicated channel interval comprises receiving a beacon, including a start time and a length of the dedicated channel time allocation interval, from the host.

16. A communication apparatus of a first device of a plurality of devices connected to a host through a wireless interface, the apparatus comprising:
a request unit which requests allocation of a dedicated channel interval in which the first device can exclusively use a channel of the wireless interface;
a reception unit which receives information on the dedicated channel interval in response to the request; and
a communication unit which communicates exclusively with the host during the dedicated channel interval, based on the information on the dedicated channel interval.

17. A computer readable recording medium having embodied thereon a computer program for a communication method of a first device of a plurality of devices connected to a host through a wireless interface, wherein the method comprises:
requesting allocation of a dedicated channel interval in which the first device can exclusively use a channel of the wireless interface;
receiving information on the dedicated channel interval in response to the request; and
communicating exclusively with the host during the dedicated channel interval, based on the information on the dedicated channel interval.
